(19) United States
(12) Patent Application Publication
(10) Pub. No.: US 2006/0195350 A1
(43) Pub. Date: Aug. 31, 2006

(54) Design review, progress check information transmission method and apparatus

(75) Inventor: Mitsuhiro Miyano, Urayasu-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/317,896

(22) Filed: Dec. 27, 2005

(30) Foreign Application Priority Data
Dec. 27, 2004 (JP) P2004-377040

(51) Int. Cl. G05B 19/418

(52) U.S. Cl. 705/8

(57) ABSTRACT

A design review, progress check information transmission method includes: a monitor condition selection and setup step (S15) of selecting and setting a plurality of desired monitor conditions based on a project name, check items, unique codes, a scheduled job start date and end date, an actual job start date and end date and acceptance/rejection information; a monitor information extraction step (S16) of extracting information based on monitoring conditions; a processing step (S17) of processing the information extracted at the monitored information extraction step to obtain the essence of information; a matching detection step (S18) of detecting matches between the monitoring conditions and post-processed information obtained at the processing step; and an email transmission step (S19) of creating email text by attaching the essence of the information and a detailed information reference URL, and transmitting the email via a communication line.

### BACKGROUND OF THE INVENTION

1. Field of the Invention

The present invention relates to a design review, progress check information transmission method and an apparatus therefor, for employing design review check results to transmit, by email, project progress information and risk information to the members of a project execution department.

2. Description of the Related Art

Various project management support methods have been proposed as project progress management methods (see, for example, JP-A-2003-6398 (pp. 6-12, FIG. 1)).

For example, the project management support method disclosed in patent document 1 is a project management support method whereby, at the least, either a project evaluation table or a project evaluation graph is created, either periodically or on request, in order to manage the progress of a project. According to this method, a project execution terminal transmits project result information to a project management support server via a communication line, and based on the received project result information, the project management support server creates, at the least, either a project evaluation table or a project evaluation graph. Then, a project management support terminal creates a comment, based on either the project evaluation table or the project evaluation graph that is received from the project management support server, and transmits the comment to the project management support server. The project management support server stores either the thus created project evaluation table, or the project evaluation graph, and the comment received from the project management support terminal. Thereafter, the project execution terminal accesses the project management support server to obtain, at the least, either the project evaluation table or the project evaluation graph, or the comment.

However, according to the conventional project management support method, for the progress management of a project, members of a project execution department must individually access a system server and query software, such as groupware, to obtain information, and obtaining information under such conditions is difficult. Furthermore, since individual members of a project execution department may request different data items, an efficient method is not available whereby the members can individually collect all information in a timely manner, adequately ascertain existing circumstances, and subsequently initiate a required action.

In addition, since for project management, not all vitally important information required for risk management can be obtained immediately, the members of a project execution department must, of necessity, individually collect and analyze a variety of information that can be used for evaluating a situation. Thus, such a process becomes arbitrary.

Therefore, members of project execution departments have expressed a desire for a method and a system whereby it is easy to obtain the essence of basic progress information and risk information.

### SUMMARY OF THE INVENTION

While taking the conventional problems into account, the objectives of the present invention are to provide a design review, progress check information transmission method whereby a defect inherent in the conventional progress management method is resolved, and the respective individual members of a project execution department can easily obtain the essence of information items they have requested, in addition to risk information, and an apparatus therefor.

To resolve these objectives, according to the invention, a design review, progress check information transmission method, for evaluating review items that are required for steps in a product development process, comprises:

a basic information setup step of establishing a design review process name, a development process name, and check items required for product development to determine business results;

a code provision setup step of selecting unique codes used for identifying the check items;

a rank setup step of designating, respectively, for a plurality of projects, rank information for job importance levels and priority levels for the check items;

a plan setup step of producing, respectively, for a plurality of jobs, schedules for job start dates and job end dates for the check items;

a result entering step of entering, respectively, for a plurality of projects, the results representing job start dates and end dates for the check items, and acceptance/rejection information pertaining to content checking;

a monitoring condition designation step, for a member of a project execution department, of selecting and entering a plurality of desired monitoring conditions by referring to a name of a project for which a progress notification and risk information is requested, the check items, the unique codes, the schedules for the job start dates and end dates, the results obtained for the job start dates and the job end dates and the acceptance/rejection information;

a monitoring information extraction step of extracting information based on the monitoring conditions;

a processing step of processing the information extracted at the monitoring information extraction step to obtain the essence of information;

a matching detection step of detecting a matching state wherein post-processed information obtained at the processing step matches the monitoring conditions; and

an email transmission step of, following the detection of the matching state, creating text for an email to which is attached the essence of information and a detailed information reference URL, and transmitting the email, via a communication line, to a designated transmission destination email address.

Furthermore, according to the invention, a design review, progress check information transmission apparatus, for evaluating review items that are required for steps in a product development process, comprises:

a basic information setup unit, for establishing a design review process name, a development process name, and check items required for product development to determine business results;

a code provision setup unit, for selecting unique codes used for identifying the check items;

a rank setup unit, for designating, respectively, for a plurality of projects, rank information for job importance levels and priority levels for the check items;

a plan setup processor, for producing, respectively, for a plurality of jobs, schedules for job start dates and job end dates for the check items;

a result entering unit, for entering, respectively, for a plurality of projects, the results related to job start dates and end dates for the check items, and acceptance/rejection information pertaining to content checking;

a monitoring condition designation unit, for a member of a project execution department, for selecting and entering a plurality of desired monitoring conditions by referring to a name of a project for which a progress notification and risk information is requested, the check items, the unique codes, the schedules for the job start dates and end dates, the results obtained for the job start dates and the job end dates and the acceptance/rejection information;

a monitoring information extraction unit, for extracting information based on the monitoring conditions;

a processing unit, for processing the information extracted by the monitoring information extraction unit to obtain the essence of information;

a matching detection unit, for detecting a matching state wherein post-processed information obtained by the processing unit matches the monitoring conditions; and

an email transmission unit, for, following the detection of the matching state, creating text for an email to which is attached the essence of information and a detailed information reference URL, and for transmitting the email, via a communication line, to a designated transmission destination email address.

According to this arrangement, since the server generates checking progress information and automatically transmits the information to the members of the project execution department, these members can easily obtain the essence of information items that have respectively been requested, without having to access a system server and query software, such as groupware.

For the design review, progress check information transmission method of this invention, the processing step includes:

a result input detection step of detecting result detection information for determining whether the results for the job start dates and the job end dates for the check items, for which the monitoring conditions have been designated, have been entered; and

a result detection information addition step of adding the result detection information as the post-processed information.

Further, for the design review, progress check information transmission apparatus of this invention, the processing unit includes:

a result input detection unit, for detecting result detection information for determining whether the results for the job start dates and the job end dates for the check items, for which the monitoring conditions have been designated, have been entered; and

a result detection information addition unit, for adding the result detection information as the post-processed information.

According to this arrangement, since the server automatically transmits, as progress check information, result information related to the job start dates and end dates for the check items, the members of the project execution department can easily obtain the essence of information items that were respectively requested, without having to access a system server and query software, such as groupware.

According to the design review, progress check information transmission method of the invention, the processing step includes:

a check item count acquisition step of obtaining a check item count, which indicates the number of check items designated during a time period for the design review process or the development process, for which monitor conditions are designated;

a result input count acquisition step of obtaining a result input count, which indicates the number of sets of results for the job start dates and the job end dates that have been entered; and

a progress achievement calculation step of calculating a progress achievement level based on the ratio of the result input count relative to the check item count.

According to the design review, progress check information transmission apparatus of the invention, the processing unit includes:

a check item count acquisition function, for obtaining a check item count, which indicates the number of check items designated during a time period for the design review process or the development process, for which monitor conditions are designated;

a result input count acquisition function, for obtaining a result input count, which indicates the number of sets of results for the job start dates and the job end dates that have been entered; and

a progress achievement calculation function, for calculating a progress achievement level based on the ratio of the result input count relative to the check item count.

According to this arrangement, since the server automatically transmits, as progress check information, progress rate information relative to check items, a stakeholder in a project can precisely ascertain the progress made on a project without having to access a system server and query software, such as groupware.

According to the design review, progress check information transmission method of this invention, the processing step includes:

a periodical monitoring step of monitoring the result input count and the progress achievement level, at a predetermined interval, for which monitoring conditions are designated in advance; and

a monitoring result addition step of adding the monitoring results as the post-processed information.

According to the design review, progress check information transmission apparatus of this invention, the processing unit includes:

a periodical monitoring function, for monitoring the result input count and the progress achievement level, at a predetermined interval, for which monitoring conditions are designated in advance; and

a monitoring result addition function, for adding the monitoring results as the post-processed information.

According to this arrangement, since at predetermined intervals the server automatically transmits, as progress check information, progress rate information related to the check items, a stakeholder in a project can periodically obtain the progressing status for the project without having to access a system server and query software, such as groupware.

According to the design review, progress check information transmission method of this invention, the processing step includes:

a history extraction step of extracting a history of the monitoring results for which monitoring conditions are designated; and

a history difference calculation step of calculating a historical difference in the monitoring results.

According to the design review, progress check information transmission apparatus of this invention, the processing unit includes:

a history extraction function, for extracting a history of the monitoring results for which monitoring conditions are designated; and

a history difference calculation function, for calculating a historical difference in the monitoring results.

According to this arrangement, since the server transmits, as progress check information, a difference in the progress history related to the check items, a stakeholder in the project can obtain the history of the progressing status for the project without having to access a system server and query software, such as groupware.

According to the design review, progress check information transmission method of the invention, the processing step includes:

a behind-schedule detection step of determining whether the job start dates and the job end dates of the check items, for which the monitoring conditions are designated, are behind schedule;

a result input detection step of determining whether results for the job start dates and the job end dates for the check items have been entered; and

a request information addition step of, when the job start dates and the job end dates are behind schedule, and when the results for the job start dates and the job end dates of the check items are not entered, adding request information as post-processed information.

According to the design review, progress check information transmission apparatus of the invention, the processing unit includes:

a behind-schedule detection function, for determining whether the job start dates and the job end dates of the check items, for which the monitoring conditions are designated, are behind schedule;

a result input detection function, for determining whether results for the job start dates and the job end dates for the check items have been entered; and

a request information addition function, for, when the job start dates and the job end dates are behind schedule, and when the results for the job start dates and the job end dates of the check items are not entered, adding request information as post-processed information.

According to this arrangement, since the server adds, as progress check information, request information related to items that, relative to the program, do not progress and transmits the information, the members of the project execution department can precisely obtain news of a delay in the schedule, and quickly execute a corresponding action item.

According to the design review, progress check information transmission method of the invention, the processing step includes a risk distribution coordinate creation step, for job importance levels and priority levels, that includes:

an orthogonal coordinates creation step of arranging cells in a matrix shape and creating orthogonal coordinates in consonance with the job importance levels and the priority levels of the check items;

a coordinate value calculation step of calculating coordinate values in accordance with sets of rank information, respectively consisting of the job importance levels and the priority levels of the check target items;

a unique code arrangement step of arranging and displaying the unique codes at the cells represented by the corresponding coordinate values; and

a hierarchical conversion step of performing a hierarchy display process for arranging the unique codes in the cells of the coordinate values.

According to the design review, progress check information transmission apparatus of the invention, the processing unit includes a risk distribution coordinate creation function, for job importance levels and priority levels, that includes:

an orthogonal coordinates creation function, for arranging cells in a matrix shape and creating orthogonal coordinates in consonance with the job importance levels and the priority levels of the check items;

a coordinate value calculation function, for calculating coordinate values in accordance with sets of rank information, respectively consisting of the job importance levels and the priority levels of the check target items;

a unique code arrangement function, for arranging and displaying the unique codes at the cells represented by the corresponding coordinate values; and

a hierarchical conversion function, for performing a hierarchy display process for arranging the unique codes in the cells of the coordinate values.

According to this arrangement, the members of the project execution department can obtain a risk trend for a project by employing a risk distribution coordinate graph.

According to the design review, progress check information transmission method of the invention, in addition to the risk distribution coordinate creation step, the processing step includes:

a display color setup step of setting a color correlation table indicating correlations, with display colors, of a non-setup state and a setup-complete state of the results for a job start date and a job end date for a check item, a behind-schedule state and a redo state; and

a progressing state color conversion step of changing colors, based on the color correlation table, of progressing states of the check items corresponding to the unique codes that are arranged in the individual cells at the risk distribution coordinates, and displaying the progressing states.

According to the design review, progress check information transmission apparatus of the invention, in addition to the risk distribution coordinate creation function, the processing unit includes:

a display color setup function, for setting a color correlation table indicating correlations, with display colors, of a non-setup state and a setup-complete state of the results for a job start date and a job end date for a check item, a behind-schedule state and a redo state; and

a progressing state color conversion function, for changing colors, based on the color correlation table, of progressing states of the check items corresponding to the unique codes that are arranged in the individual cells at the risk distribution coordinates, and displaying the progressing states.

According to this arrangement, the members of the project execution department can also understand the progressing states of the individual items displayed, using different colors, on the risk distribution coordinate graph.

According to the design review, progress check information transmission method of this invention, in addition to the risk distribution coordinates creation step, the processing step includes:

a risk group sorting step of dividing the X axis and the Y axis for an orthogonal coordinating system in accordance with arbitrary rank values for the job importance levels and priority levels of the check items, and sorting the orthogonal coordinating system into risk groups located in four areas based on the importance levels and the priority levels;

a group check item count acquisition step of obtaining the number of check items that are entered in each of the four areas of the risk groups; and

a current status acquisition step of obtaining, for each of the areas of the risk groups, the number of items indicating a non-setup state and a setup-complete state of the results for the job start date and the job end date of the check item, a behind-schedule state and a redo state; and

a risk group status aggregation step of aggregating current status values for the individual areas of the risk groups.

According to the design review, progress check information transmission apparatus of this invention, in addition to the risk distribution coordinates creation function, the processing unit includes:

a risk group sorting function, for dividing the X axis and the Y axis for an orthogonal coordinating system in accordance with arbitrary rank values for the job importance levels and priority levels of the check items, and sorting the orthogonal coordinating system into risk groups located in four areas based on the importance levels and the priority levels;

a group check item count acquisition function, for obtaining the number of check items that are entered in each of the four areas of the risk groups; and

a current status acquisition function, for obtaining, for each of the areas of the risk groups, the number of items indicating a non-setup state and a setup-complete state of the results for the job start date and the job end date of the check item, a behind-schedule state and a redo state; and

a risk group status aggregation function, for aggregating current status values for the individual areas of the risk groups.

According to this arrangement, the members of the project execution department can obtain the progress status for each risk group.

According to this invention, members of a project execution department can easily obtain the essence of information items respectively requested, without having to access a system server query software, such as groupware, and further, can obtain risk information, such as risk distribution or the degree of risk, to execute the succeeding action item. Therefore, the project management function can be performed efficiently.

### BRIEF DESCRIPTION OF THE DRAWINGS

FIG. 1 is a diagram showing the configuration of a progress check information transmission system according to a first embodiment of the present invention.

FIG. 2 is a flowchart showing the progress check information transmission operation performed by the progress check information transmission system according to the first embodiment.

FIG. 3 is a flowchart showing the extracted information processing performed by a design review, progress check information transmission system according to a second embodiment of the invention.

FIG. 4 is a flowchart showing the extracted information processing performed by a design review, progress check information transmission system according to a third embodiment of the invention.

FIG. 5 is a flowchart showing the extracted information processing performed by a design review, progress check information transmission system according to a fourth embodiment of the invention.

FIG. 6 is a flowchart showing the extracted information processing performed by a design review, progress check information transmission system according to a fifth embodiment of the invention.

FIG. 7 is a flowchart showing the extracted information processing performed by a design review, progress check information transmission system according to a sixth embodiment of the invention.

FIG. 8 is a flowchart showing the extracted information processing performed by a design review, progress check information transmission system according to a seventh embodiment of the invention.

FIG. 9 is a flowchart showing the extracted information processing performed by a design review, progress check information transmission system according to an eighth embodiment of the invention.

FIG. 10 is a diagram showing an overview of a product development process.

FIG. 11 is a diagram showing example check items for a design review.

FIG. 12 is a diagram showing example rank evaluation guide lines for job importance levels and priority levels.

FIG. 13 is a diagram showing an example for allocation of importance levels and priority levels to ID codes that are correlated with check items.

FIG. 14 is a diagram showing an example screen for setting monitor conditions.

FIG. 15 is a diagram showing an example screen displayed after extracted information has been processed.

FIG. 16 is a diagram showing an example screen displayed after extracted information has been processed.

FIG. 17 is a diagram showing an example display screen for email text.

FIG. 18 is a diagram showing an example display screen for email text.

FIG. 19 is a diagram showing an overview for the calculation of a progress achievement level.

FIG. 20 is a diagram showing an example display screen for an email representing progress check information that includes a monitoring history.

FIG. 21 is a diagram showing an example display screen for an email representing progress check information to which request information has been added.

FIG. 22 is a diagram showing an overview of a risk distribution coordinate graph.

FIG. 23 is a diagram showing an overview of a risk distribution coordinate graph (with display using detail browsing buttons).

FIG. 24 is a diagram showing a color correlation table for designating colors corresponding to progress status.

FIG. 25 is a diagram showing an overview of a risk distribution coordinate graph displayed in different colors.

FIG. 26 is a diagram showing an overview of a risk distribution coordinate graph displayed in different colors (with display using detail browsing buttons).

FIG. 27 is a diagram showing an overview of four areas obtained by dividing a risk distribution coordinate graph.

FIG. 28 is a diagram showing an example display screen for an email representing progress check information to which progress achievement level information has been added for each risk group.

### DESCRIPTION OF THE PREFERRED EMBODIMENTS

### First Embodiment

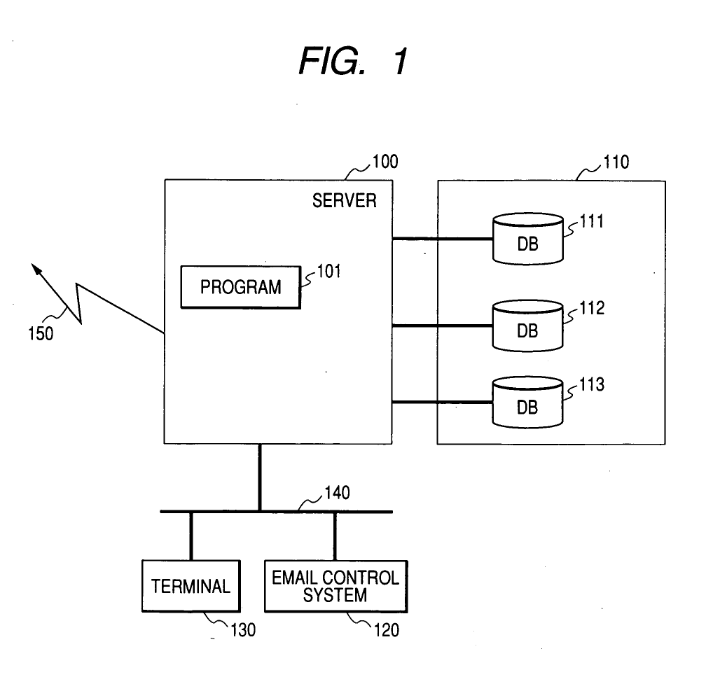

FIG. 1 is a diagram showing the configuration of a progress check information transmission system according to a first embodiment of the present invention. The progress check information transmission system mainly comprises: a server 100, a database unit 110, an email control system 120 and a plurality of terminals 130.

The server 100 employs a resource, such as the database unit 110, to provide overall control for the function of the progress check information transmission system. In the server 100, a table of check items and procedures for a basic information setup process and a code provision setup process are stored as a program 101, and the individual functions are performed when the server 100 executes this program 101. Further, the server 100 is connected to the email control system 120 and the terminals 130, such as a personal computer and a notebook computer, via a line 140, and is also connected to individual departments, such as a project execution department, via a network 150.

The database unit 110 stores various types of data to be employed by the server 100. In this embodiment, data that are to be stored are sorted for the individual databases. For example, check item information and project management information are compressed and stored in a database 111, and check result information and job importance level, as well as priority level information, are compressed and stored in a database 112, while relevant email information is compressed and stored in a database 113.

The email control system 120 is a system for controlling the transmission and reception of email, and controls, for example, the transmission of email including progress check information generated by the server 100.

The terminals 130 designate the server 100, or enter data in the database unit 110.

As an example application for this configuration, a design information management system that manages design information and a parts information database system that stores information related to parts required for product development may cooperate.

The operation of the thus arranged progress check information transmission system will now be described. It should be noted that the following operation is performed when the server 100 executes the program 101 stored therein.

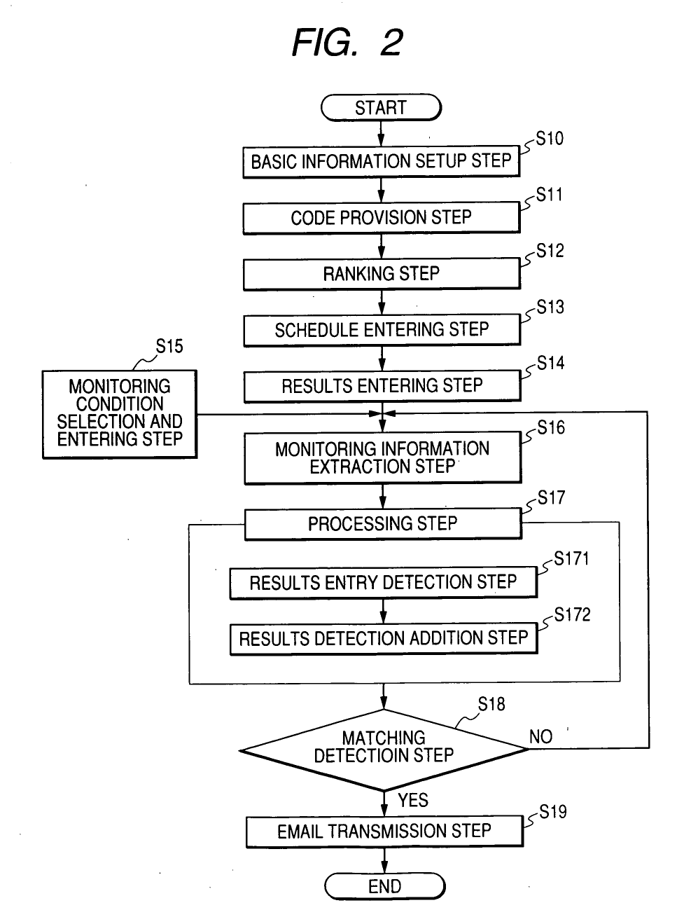

FIG. 2 is a flow chart showing the procedures for the progress check information transmission operation of the progress check information transmission system according to this embodiment. First, for design review checking consisting of the evaluation of inspection items required for the individual product development steps, the server 100 executes setups related to basic information, such as the name of a design review process, a development process and check items for which job results obtained through product development are determined (step S10). These setups may be entered by a person in charge using the terminal 130, or via the network 150 through a terminal (not shown) in the department of the person who is in charge.

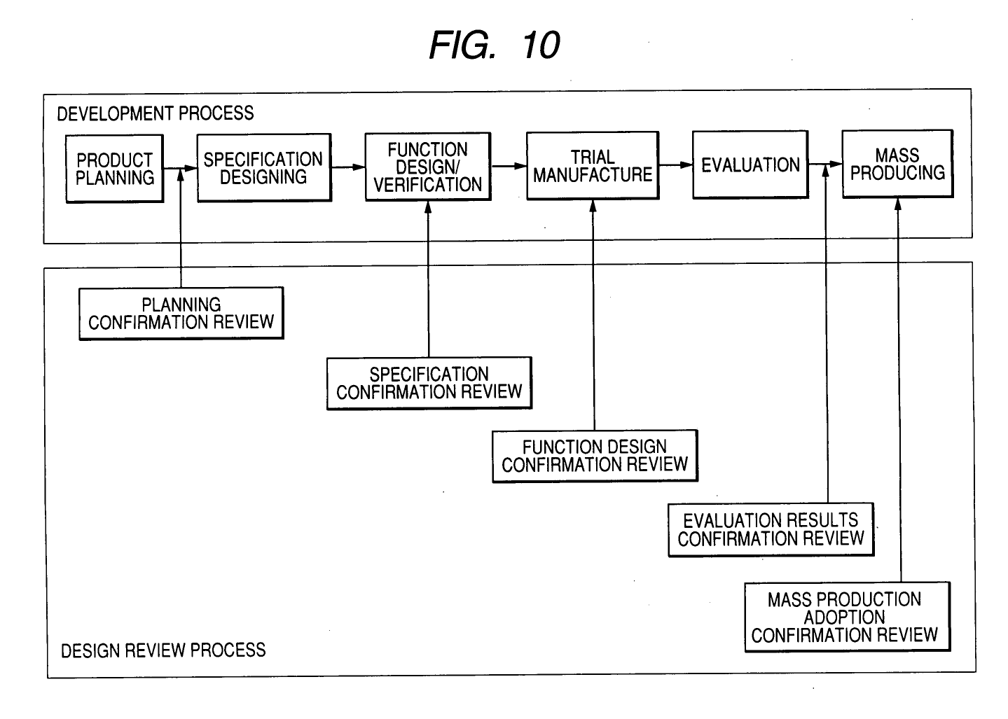

The product development process will now be explained. FIG. 10 is a diagram showing an overview of the product development process. The product development process generally includes product planning, specification design, function design/verification, trial manufacture, evaluation and mass producing phases. In consonance with the phases of the development process, the planning confirmation review, the specification confirmation review, the function design confirmation review, the result evaluation confirmation review and the mass production adoption confirmation review are performed. According to the design review, an evaluation is performed of the design procedures required for the development process and the individual inspection items (hereinafter referred to as check items), such as design verification.

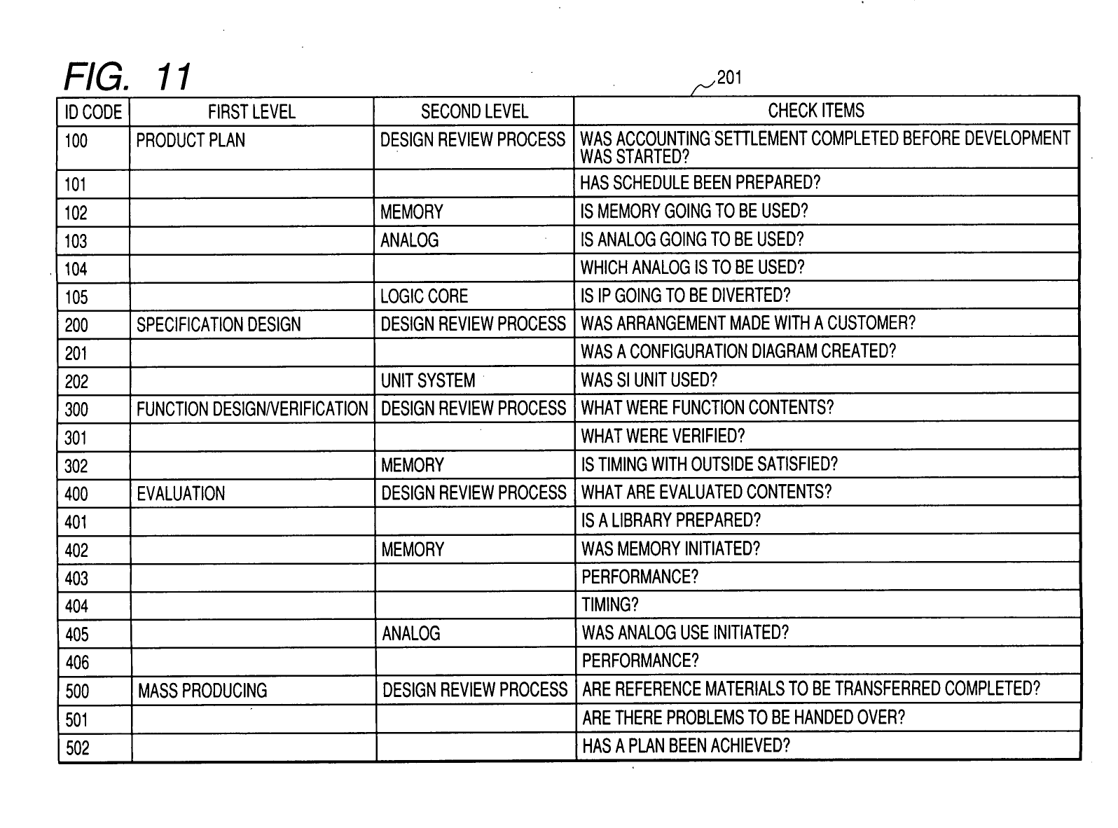

FIG. 11 is a diagram showing example check items for the design review. As shown in FIG. 11, the check items are, for example, “Is accounting settlement completed before the development process is started?” and “Is analog going to be used?”. It should be noted that progress checking performed for the design review is linked with product development progress.

Next, the server 100 provides unique codes for identifying check items (step S11). According to the example in FIG. 11, ID codes 201 are allocated for the individual check items as unique codes used to easily establish a system.

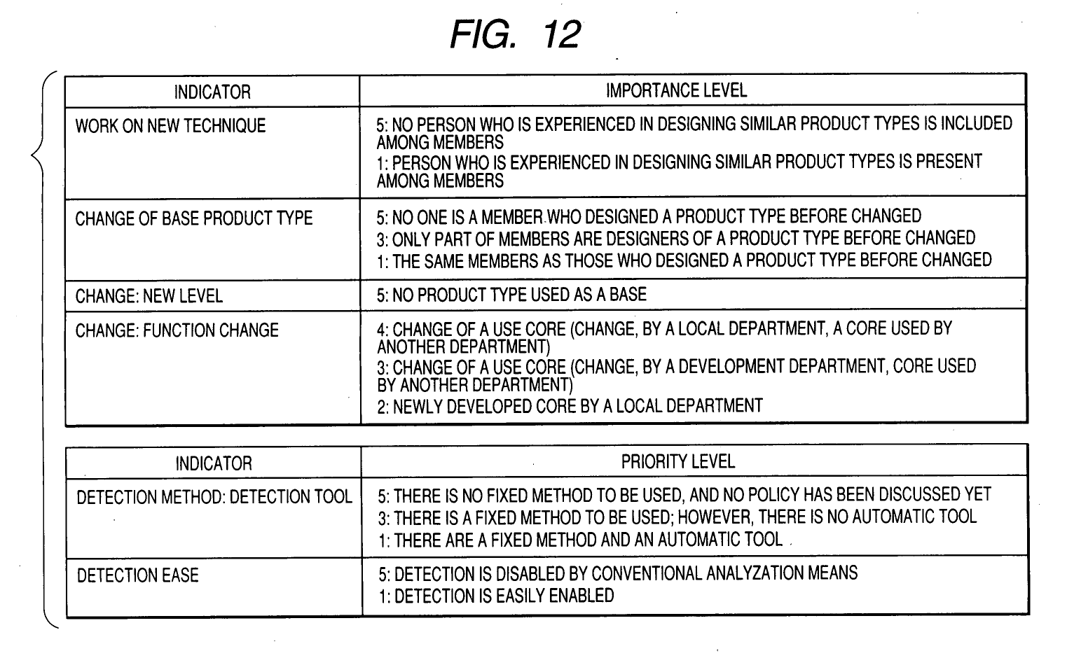

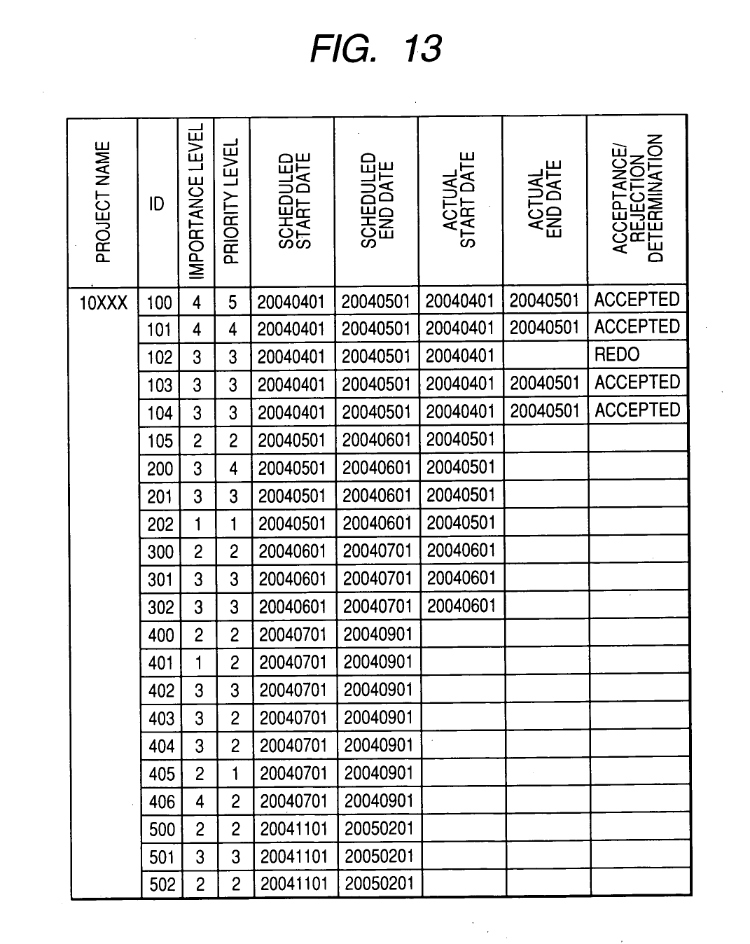

Following this, for each of a plurality of projects, the server 100 ranks job importance levels and priority levels for the check items (step S12). FIG. 12 is a diagram showing example rank evaluation guidelines for the job importance levels and priority levels. For the importance levels and the priority levels of the check items, for example, a project leader designates ranks, based on the evaluation guidelines in FIG. 12, for the individual projects. FIG. 13 is a diagram showing an example wherein importance levels and priority levels are ranked for ID codes correlated with check items. By referring to this example, important operations and other operations, timetables of which should be punctual can be clearly understood for each project. It should be noted that the setups may be performed by a project leader using the terminal 130, or via the network 150 using a terminal (not shown) in the department that the project leader belongs to. Furthermore, these setups may be copied from other project information.

Following this, the server 100 sets the job start dates and end dates for the check items for each of the projects (step S13). Say, for example, a project leader enters, at the time of product planning, or changes, for the individual development phases, the schedules for the job start dates and end dates relative to ID codes correlated with the check items, as shown in FIG. 13. As is described above, these setups may be performed by a project leader using the terminal 130, or via the network 150 through the terminal (not shown) of the department that the project leader belongs to.

Sequentially, the server 100 sets, for each of the projects, the results obtained for the job start dates and end dates for the check items, and information related to acceptance or rejection of the check contents (step S14). Say, for example, a person in charge is a development department member, and this person in charge prepares a design procedure job and a design verification job for product development and, as shown in FIG. 13, enters as evaluation results, results obtained for the job start dates and end dates relative to ID codes that are correlated with the check items, and information relating to acceptance and rejection of the check contents. It should be noted that these setups may be performed by the development department member in charge using the terminal 130, or via the network 150 through a terminal (not shown) in the department to which the development department member in charge belongs.

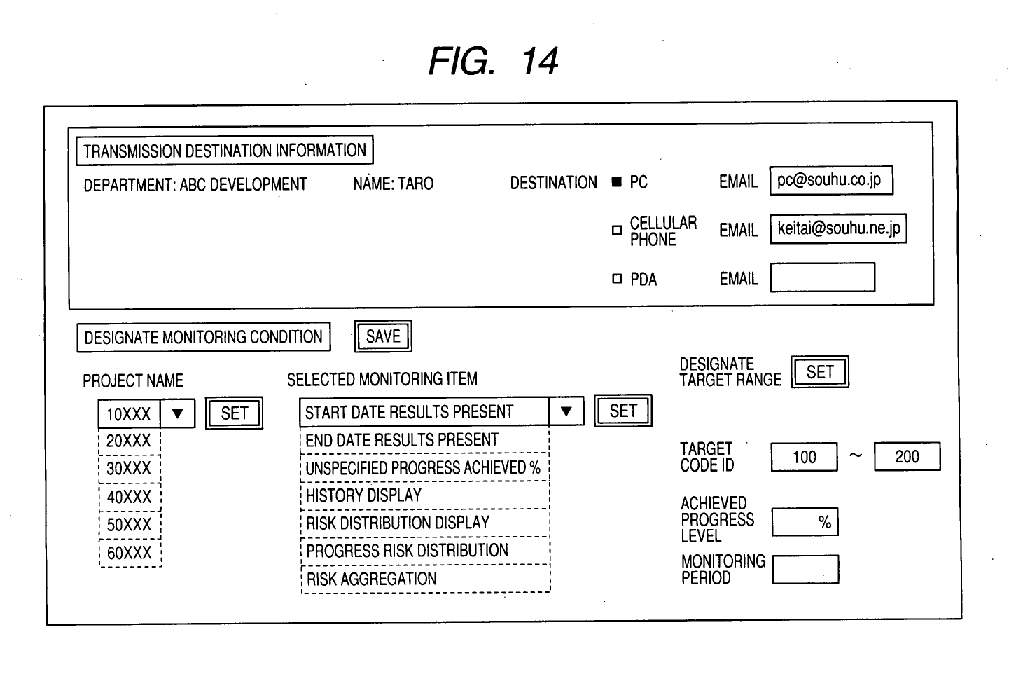

In this embodiment, the server 100 sets, in advance, items designated as monitor conditions that a member of the project execution department desires (step S15) Based on instructions entered by the member of the project execution department, setups are performed for a plurality of items, such as a project name for which a notification of progress and risk information is requested, check items, unique codes, a schedule for job start dates and end dates, results obtained for job start dates and end dates, and accept/reject information. FIG. 14 is a diagram showing an example monitor condition setup screen. As shown in FIG. 14, each stakeholder can designate, for example, the name of a project for which automatic notification of a progress state and risk information is desired, conditions for the automatic notification, and the email address for the notification. The information notification destination can be, for example, a personal computer, a notebook computer, a mobile tool, a cellular phone or a PDA. It should be noted that the setup may be performed by each stakeholder using the terminal 130, or via the network 150 through a terminal (not shown) in the department to which the stakeholder belongs.

Then, the server 100 extracts monitor information, based on the monitor conditions designated in advance (step S16). The monitor information is, for example, the number of check items that are in the function design/verification stage, or the number of items for which work has been completed.

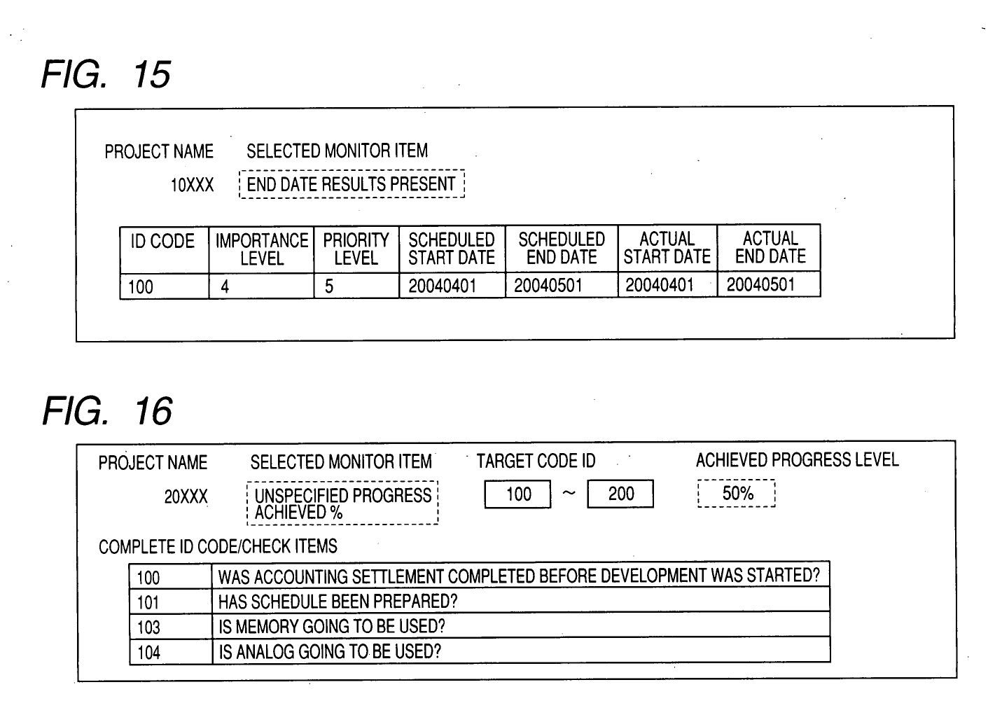

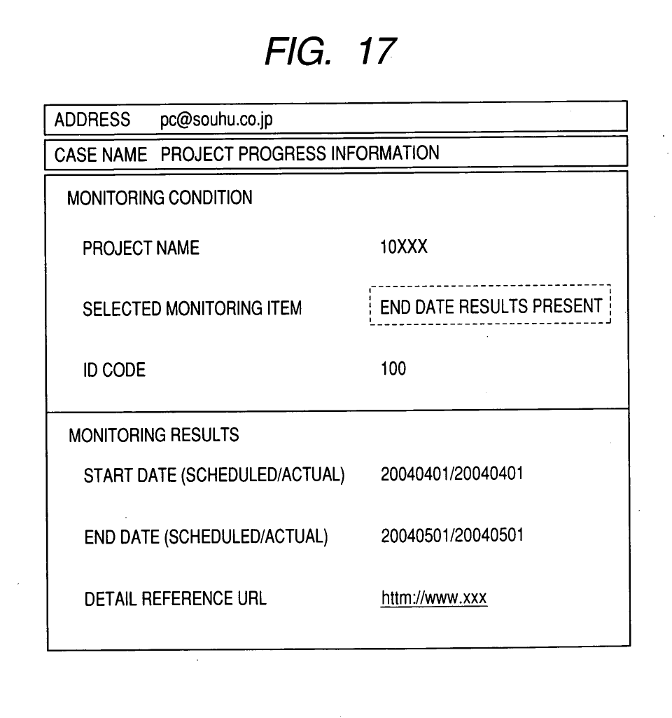

Next, the server 100 processes the extracted monitor information to obtain the essence of information (step S17) In this embodiment, as examples of this process, an explanation will be given for a result entry detection process (step S171), for detecting an entry related to the results obtained for job start dates and end dates for check items for which the monitoring conditions have been designated, and a result detection addition process (step S172), for the transmission, by email, of result detection information. FIGS. 15 and 16 are diagrams showing example screens displayed after the extracted information has been processed. As shown in FIGS. 15 and 16, the project name entered by the stakeholder, the results obtained for job start dates and end dates for check item, “Was accounting settlement completed before development was started?”, and acceptance/rejection information are processed as contents for an email notification.

Following this, the server 100 detects matches between the predesignated monitor conditions and the information obtained by the processing (step S18). During this process, it is determined, for example, whether results have been entered for the job start dates and end dates for check item, “Was accounting settlement completed before development was started?”, for the project name designated by the stakeholder. When the monitor conditions and the information do not match, program control returns to the monitor information extraction process at step S16 and the process described above is repeated.

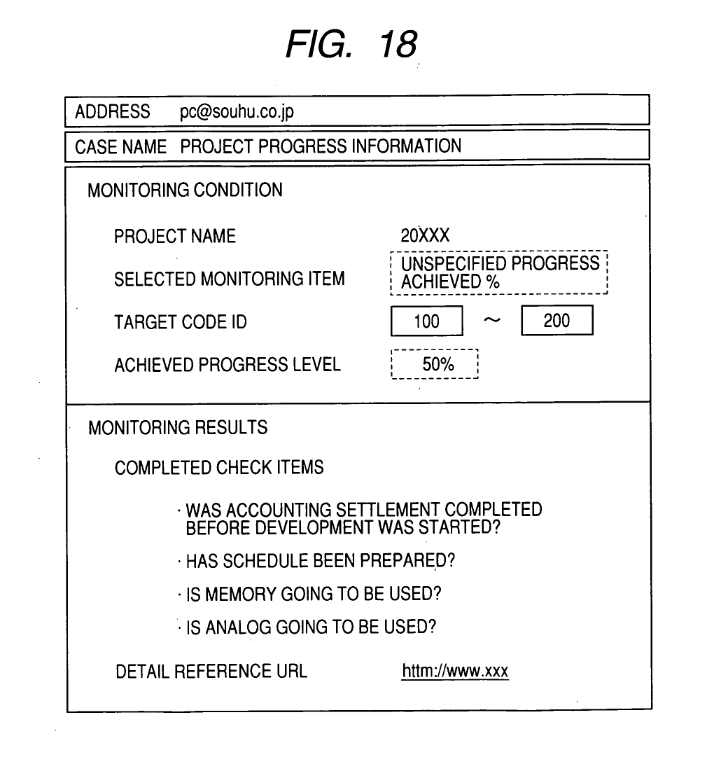

When a match is detected, the server 100 creates the email text by including the essence of information and a detailed information reference URL, and transmits this email to the designated email address via a communication line 200 (step S19). When it is detected, for example, that the results have been entered for the job start dates and end dates of check item, “Was accounting settlement completed before development was started?”, for the project name designated by the stakeholder, the email text shown in FIGS. 17 or 18 is created by attaching a detailed information reference URL to the notification contents shown in FIG. 15 or 16. Thereafter, the email is transmitted to a designated email address.

The progress check information transmission operation is then terminated. As described above, since the server generates the progress check information and transmits it automatically, the members of the project execution department can obtain the progress check information during the development process, without having to access the server.

### Second Embodiment

A design review, progress check information transmission system according to a second embodiment of the present invention will now be described. The progress check information transmission system of this embodiment differs from the system of the first embodiment in that a progress achievement level is calculated and transmitted as a notification. Since the configuration of the system and the operation, other than the extracted information processing, are the same as those for the first embodiment, no further explanation for them will be given

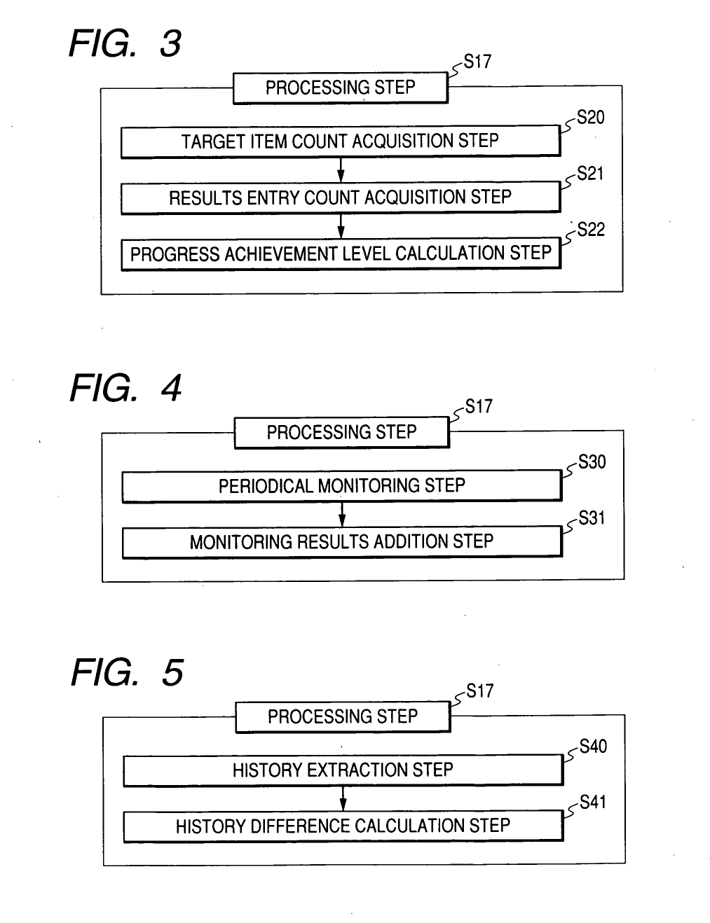

FIG. 3 is a flowchart showing the extracted information processing performed by the design review, progress check information transmission system according to the second embodiment of the present invention. During the extracted information processing, the server 100 calculates the number of check items designated during the period for the design review process or the development process, while performing monitoring under conditions relevant to the project names entered by the stakeholder (step S20). Then, the server 100 obtains a results set count for those check items for which the results obtained for job start dates and end dates have been entered (step S21).

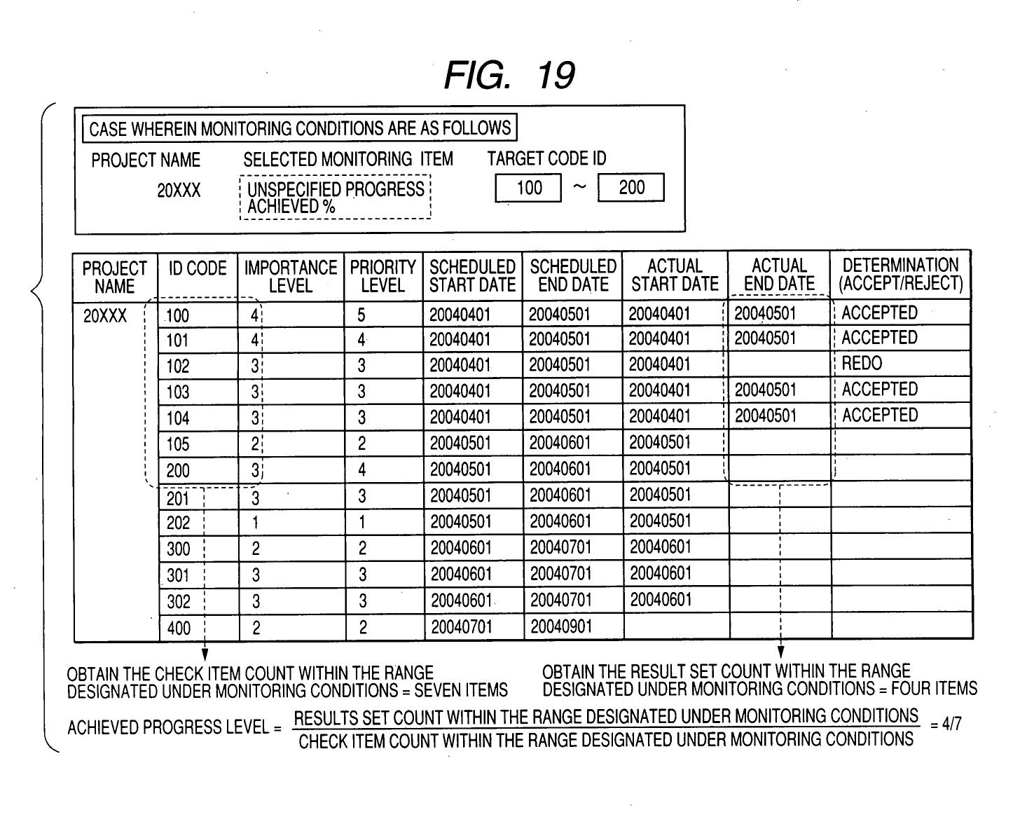

FIG. 19 is a diagram showing an overview for the calculation of a progress achievement level. Based, for example, on the monitoring conditions, the server 100 calculates the number of check items, such as, “Was accounting settlement completed before development was started?”, designated for the product planning, and sequentially, in the same manner, calculates the number of check items for which the results obtained for job start dates and end dates have been entered.

Following this, the server 100 calculates a progress achievement level in accordance with the ratio of the results set count to the check item count (step S22). As shown in FIG. 19, the progress achievement level is obtained by dividing, by the total number of check items for product planning, the number of check items for which actual dates have been entered. Therefore, the stakeholder can specifically obtain the progressing status of the project. Further, the stakeholder can designate flexible monitoring conditions, such as the transmission of a notification when the progressing rate exceeds 50%.

### Third Embodiment

A design review, progress check information transmission system will now be described according to a third embodiment of the present invention. The progress check information transmission system of this embodiment differs from the system of the second embodiment in that the calculation and the transmission of progress achievement level notifications are performed at predetermined intervals. Since the configuration of the system and the operation, other than the extracted information processing, are the same as those for the first embodiment, no further explanation for them will be given FIG. 4 is a flowchart showing the extracted information processing performed by the design review, progress check information transmission system according to the third embodiment of this invention. During the extracted information processing, the server 100 performs the calculation of the progress achievement level at predetermined intervals under designated monitoring conditions (step S30), and adds the monitoring results (step S31). Therefore, the stakeholder of a project can obtain the progress achievement levels of check items for product planning at, for example, monthly or weekly intervals.

### Fourth Embodiment

A design review, progress check information transmission system will now be described according to a fourth embodiment of the present invention. The progress check information transmission system of this embodiment differs from the system of the first embodiment in that a history of progress check information to be monitored is obtained and is used for notifications that are transmitted.

Since the configuration of the system and the operation, other than the extracted information processing, are those of the first embodiment, no further explanation for them will be given.

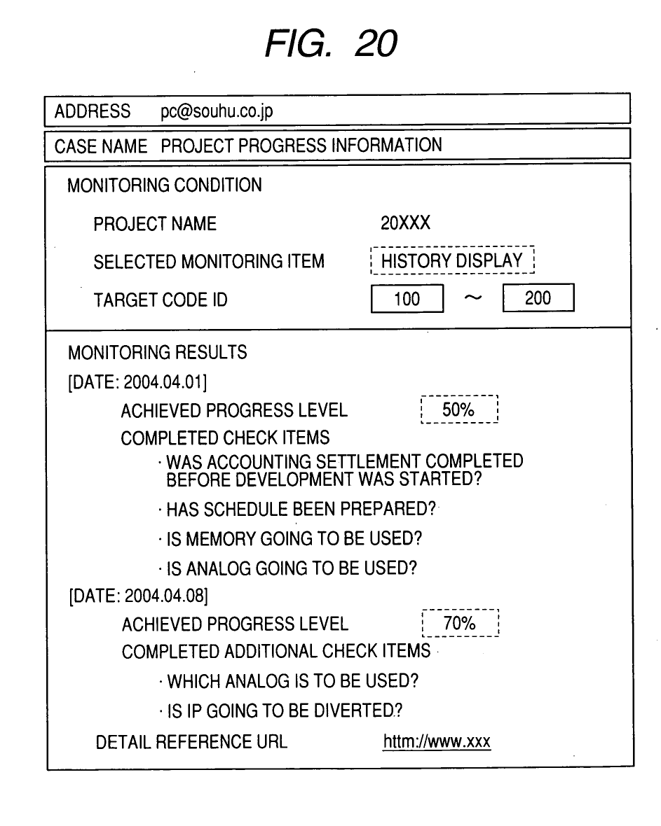

FIG. 5 is a flowchart showing the extracted information processing performed by the design review, progress check information transmission system according to the fourth embodiment of the invention. During the extracted information processing, the server 100 extracts a history of monitoring results obtained under designated monitoring conditions (step S40), and calculates a difference in the history of monitoring results (step S41). FIG. 20 is a diagram showing an example screen, for a progress check information email in which a monitor history is displayed. As shown in FIG. 20, the history of the progress achievement levels, using differences, of check items is used for notifications transmitted at weekly intervals.

### Fifth Embodiment

A design review, progress check information transmission information system will now be described according to a fifth embodiment of the present invention. The progress check information transmission system of this embodiment differs from the system of the first embodiment in that request information related to an item for which the progress relative to a plan is additionally transmitted in notifications. Since the configuration of the system and the operation, other than the extracted information processing, are the same as those for the first embodiment, no further explanation for them will be given

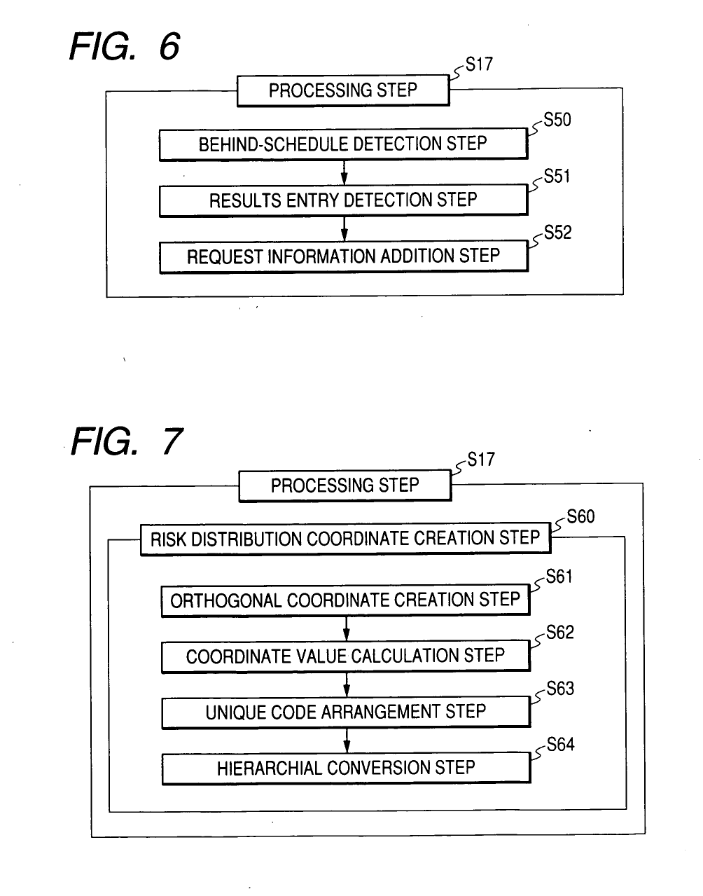

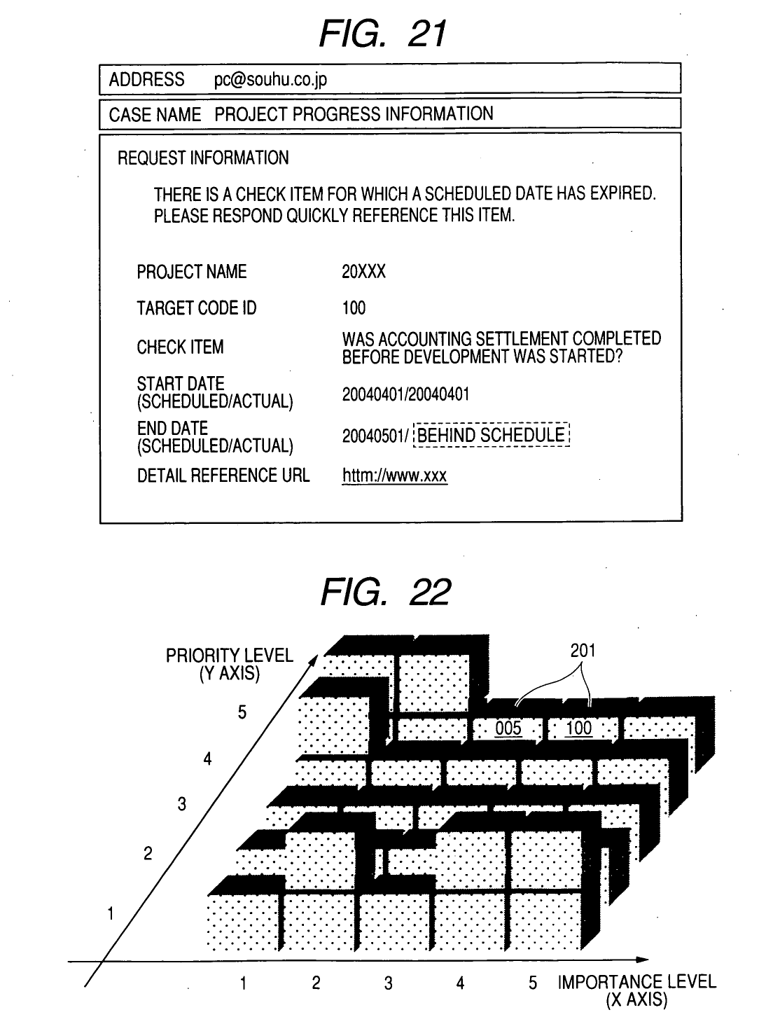

FIG. 6 is a flowchart showing the extracted information processing performed by the design review, progress check information transmission system according to the fifth embodiment of the invention. During the extracted information processing, the server 100 determines whether the scheduled job start dates and end dates for the check items, for which monitoring conditions have been designated, are behind the time table (step S50). Then, whether the results of the job start dates and end dates for the check items are entered is detected (step S51). When the schedule for the job start dates and end dates is behind that established by the time table, and when results obtained for the job start dates and end dates are not entered for the check items, request information is added (step S52). FIG. 21 is a diagram showing an example screen for displaying a progress check information email to which request information has been added. As shown in FIG. 21, when, for example, a job for checking on, “Was accounting settlement completed before development was started?”, designated for product planning, is not completed before a scheduled date has elapsed, a request to that effect is entered.

### Sixth Embodiment

A design review, progress check information transmission system will now be described according to a sixth embodiment of the present invention. The progress check information transmission system of this embodiment differs from the system of the first embodiment in that risk distribution coordinates are generated. Since the configuration of the system and the operation, other than the extracted information processing, are the same as those for the first embodiment, no further explanation for them will be given

FIG. 7 is a flowchart showing the extracted information processing performed by the design review, progress check information transmission system according to the sixth embodiment of the invention. In the extracted information processing step, included is a risk distribution coordinate creation step (step S60) that includes an orthogonal coordinate creation step, a coordinate value calculation step, a unique code arrangement step and a hierarchy conversion step.

During the extracted information processing, the server 100 creates an orthogonal coordinating system wherein squares are arranged in a matrix shape in accordance with rank information for job importance levels, and priority levels for check items (step S61).

FIG. 22 is a diagram in which is shown an overview of the risk distribution coordinate graph. As shown in FIG. 22, the X axis represents the job importance level for a check item, while the Y axis represents the job priority level for of the check item, and the orthogonal coordinates are generated using a rank value in accordance with the rank evaluation guide line of the job importance level and the priority level.

Sequentially, a coordinate value is obtained based on a combination of rank information for the job importance level and the priority level for each check item (step S62). For example, for check item, “Was accounting settlement completed before development was started?”, designated for product planning, when the rank of the job importance level is designated as 3 and the rank of the working priority level is designated as 5, the coordinate value is (3, 5).

Following this, the server 100 arranges and displays unique codes at the squares at corresponding coordinate values that have been thus calculated (step S63). For example, when the ID code 201 for “005” is designated for check item, “Was accounting settlement completed before development was started?”, designated for product planning, text “005” is arranged and displayed at the square for the orthogonal coordinate (3, 5), as shown in FIG. 22.

Thereafter, when a plurality of unique codes have been arranged at the squares for the coordinate values, these unique codes are displayed in a hierarchical manner (step S64). For example, when a plurality of check items are present at the square of orthogonal coordinate (3, 5), as shown in FIG. 22, these are so displayed that the rectangular parallelepipeds are laminated. By referring to this risk distribution coordinate graph, the members of the project execution department can obtain the trend of the risk for the project.

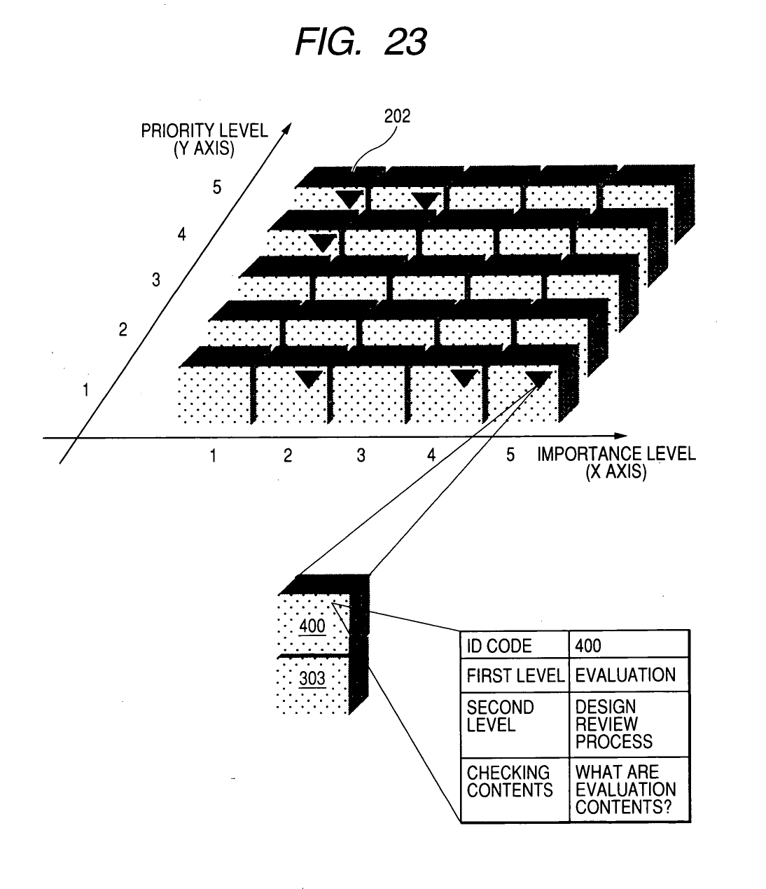

As shown in FIG. 23, detail browsing buttons (pull down buttons) 202 may be arranged for the individual coordinates, and by clicking on the button 202, the detailed state of a risk distribution may be displayed.

### Seventh Embodiment

A design review, progress check information transmission system will now be described according to a seventh embodiment of the present invention. The progress check information transmission system of the embodiment is the same as that for the sixth embodiment in that a risk distribution coordinate graph is created and is displayed using different colors so the progress status can be understood. Since the configuration of the system and the operation, other than the extracted information processing, is the same as those for the first embodiment, no further explanation for them will be given.

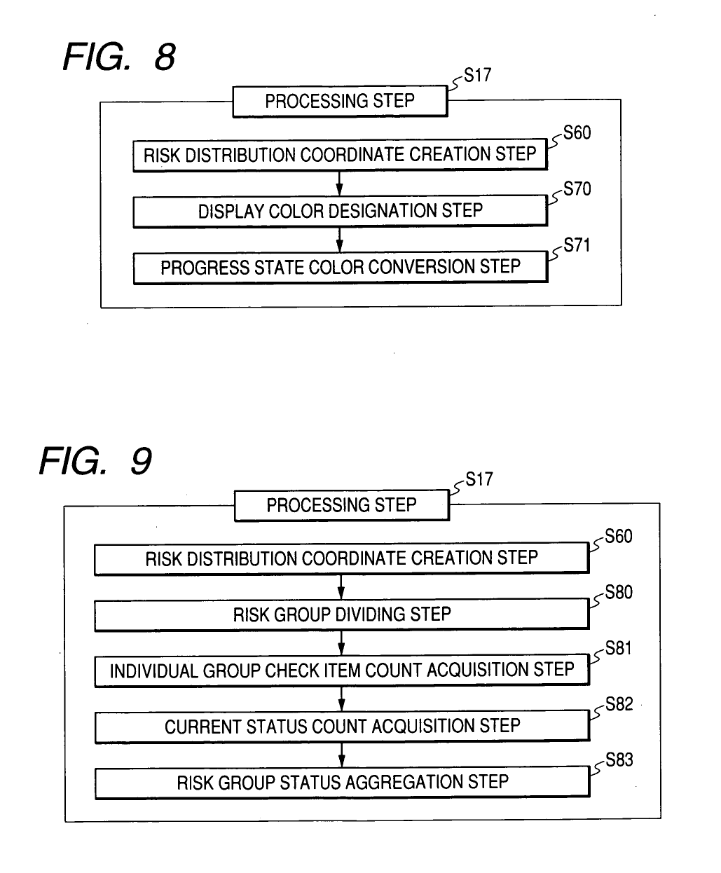

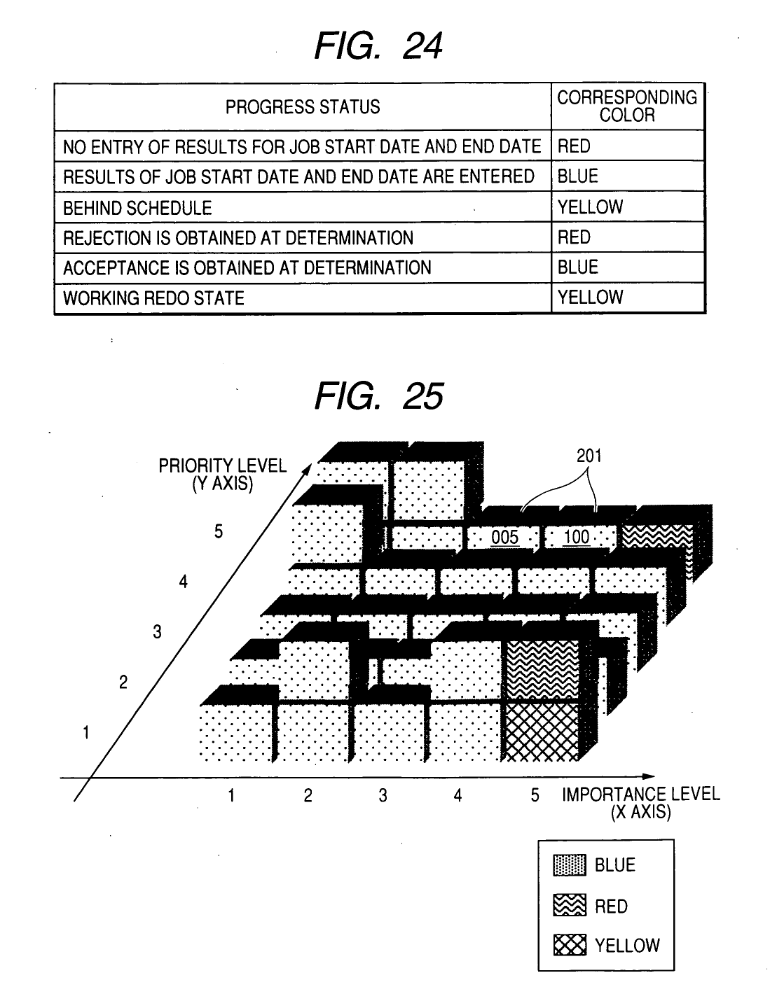

FIG. 8 is a flowchart showing the extracted information processing performed by the design review, progress check information transmission system according to the seventh embodiment. During the extracted information processing, the server 100 generates a risk distribution coordinate graph (step S60), and designates a color correlation table representing correlations between the states of check items, such as the state wherein the results of job start dates and end dates have not yet been entered and the state wherein they have been entered, a behind-schedule state and a redo state, and display colors (step S70). FIG. 24 is a diagram showing a color correlation table for designating a color for each corresponding progress status. The project leader, for example, designates a corresponding color for each progress status in FIG. 24.

Based on the color correlation table, the server 100 changes colors and displays the progress status for the check items that correspond to the ID codes 201 that are arranged at the individual squares indicated by the disk distribution coordinates (step S71). FIG. 25 is a diagram in which is shown an overview of the risk distribution coordinate graph that is displayed using different colors. As shown in FIG. 25, when check item, “Was accounting settlement completed before development was started?”, designated for product planning, is completed, “005” is displayed in blue at the square for the orthogonal coordinates (3, 5).

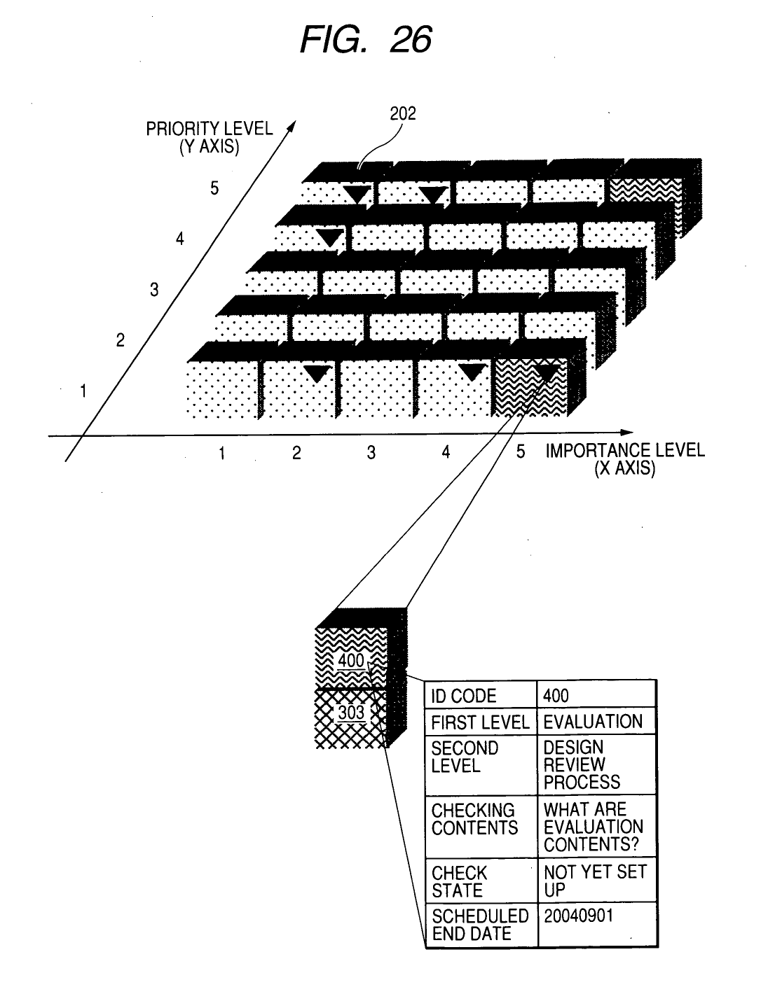

As shown in FIG. 26, detail browsing buttons (pull down buttons) 202 may be arranged for the individual coordinates, and by clicking on the button 202, the detailed state of a risk distribution may be displayed.

### Eighth Embodiment

A design review, progress check information transmission system will now be described according to an eighth embodiment of the present invention. The progress check information transmission system according to this embodiment differs from the system of the seventh embodiment in that a progress status is obtained and a notification is transmitted to each risk group. Since the configuration of the system and the operation, other than the extracted information processing, are the same as those for the first embodiment, no further explanation for them will be given.

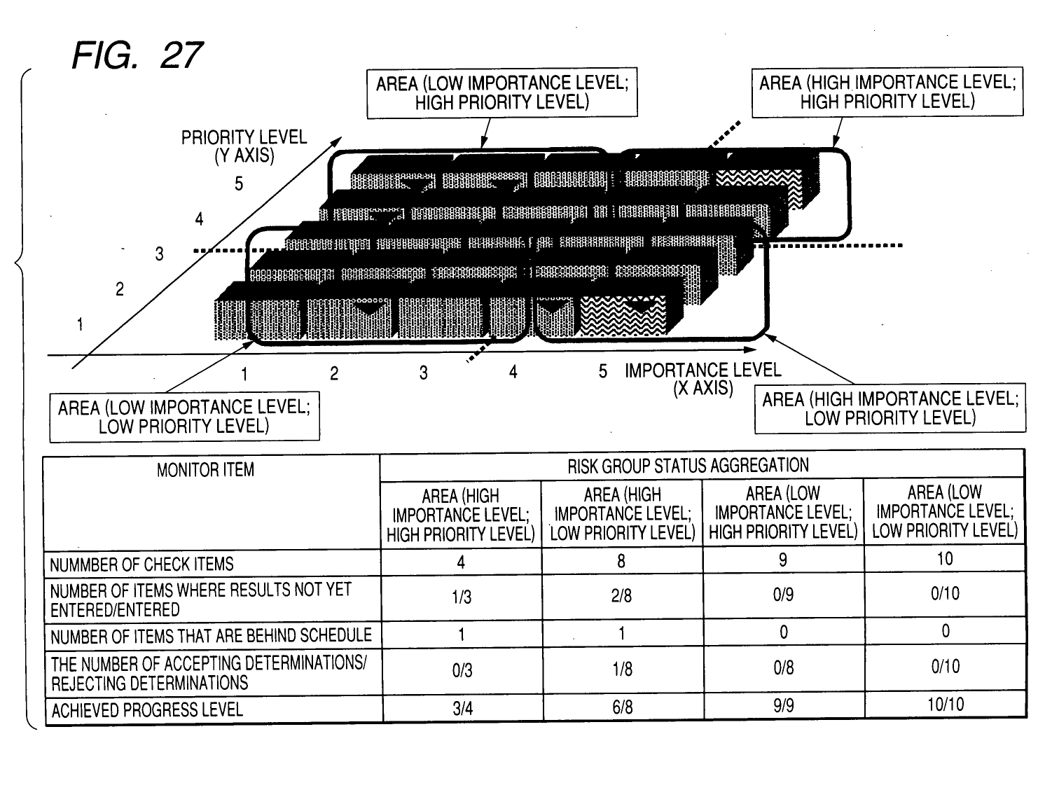

FIG. 9 is a flowchart showing the extracted information processing performed by the design review, progress check information transmission system according to the eighth embodiment. During the extracted information processing, the server generates a risk distribution coordinate graph (step S60), divides the orthogonal coordinating X and Y axes of the risk distribution coordinate graph to obtain arbitrary rank values for the working importance level and the priority level of a check item. Thus, risk groups in four areas, i.e., (high importance level, high priority level), (high importance level, low priority level), (low importance level, high priority level) and (low importance level, low priority level), are obtained (step S80). FIG. 27 is a diagram in which an overview is shown wherein the disk distribution coordinates are divided into four areas. When the risk distribution coordinates are divided at an importance level of 3 and a priority level of 3, as shown in FIG. 27, four areas are obtained.

Following this, the server 100 counts the number of check items that are designated for each risk group area (step S81) Further, the server 100 counts, for each risk group area, the number of items for the current status, such as the state wherein the results of job start dates and end dates have not yet been entered and the state wherein they have been entered, the behind-schedule state and the redo state (step S82).

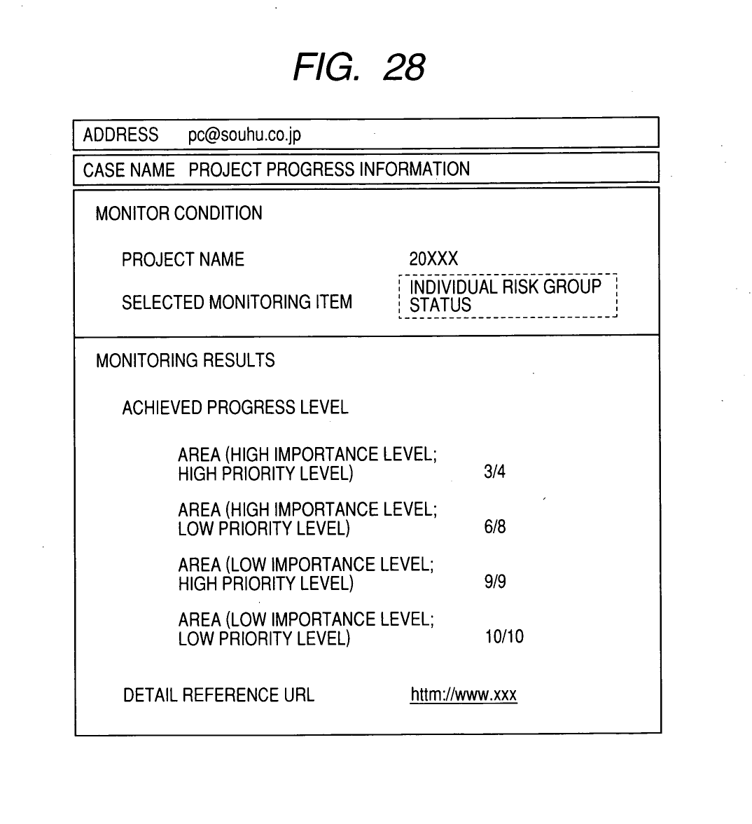

The current status values for the individual risk group areas are aggregated (step S83), and as shown in the table in FIG. 27, the progress achievement levels for the individual groups are aggregated. As a result, the members of the project execution department can obtain the progress status for the individual risk groups. FIG. 28 is a diagram showing an example screen for displaying email representing progress check information with progress achievement level information attached for each risk group.

As described above, according to the progress check information transmission method of this invention, individual members of the project execution department can easily obtain the essence of the respectively requested information items, without having to access the server. Therefore, the progress management conditions and the risk management can be easily understood, and design productivity can be improved.

According to the design review, progress check information transmission method and the apparatus of this invention, the members of the project execution department can easily obtain the essence of the respectively requested information items, without having to access the system server and query software such as groupware, and can further obtain risk information, such as the risk distribution or the degree of risk, and execute the succeeding action item. Thus, the invention can provide effects that enable project management to be efficiently performed, and that facilitate use of the design review, progress check information transmission method and the apparatus for employing the design review checking results to transmit, by email, progress information and risk information for a project to the members of the project execution department.

What is claimed is:

1. A design review, progress check information transmission method, for evaluating review items that are required for steps in a product development process, comprising:
a basic information setup step of establishing a design review process name, a development process name, and check items required for product development to determine business results;
a code provision setup step of selecting unique codes used for identifying the check items;
a rank setup step of designating, respectively, for a plurality of projects, rank information for job importance levels and priority levels for the check items;
a plan setup step of producing, respectively, for a plurality of jobs, schedules for job start dates and job end dates for the check items;
a result entering step of entering, respectively, for a plurality of projects, the results representing job start dates and end dates for the check items, and acceptance/rejection information pertaining to content checking;
a monitoring condition designation step, for a member of a project execution department, of selecting and entering a plurality of desired monitoring conditions by referring to a name of a project for which a progress notification and risk information is requested, the check items, the unique codes, the schedules for the job start dates and end dates, the results obtained for the job start dates and the job end dates and the acceptance/rejection information;
a monitoring information extraction step of extracting information based on the monitoring conditions;
a processing step of processing the information extracted at the monitoring information extraction step to obtain the essence of information;
a matching detection step of detecting a matching state wherein post-processed information obtained at the processing step matches the monitoring conditions; and
an email transmission step of, following the detection of the matching state, creating text for an email to which is attached the essence of information and a detailed information reference URL, and transmitting the email, via a communication line, to a designated transmission destination email address.

2. The design review, progress check information transmission method according to claim 1, whereby the processing step includes:
a result input detection step of detecting result detection information for determining whether the results for the job start dates and the job end dates for the check items, for which the monitoring conditions have been designated, have been entered; and
a result detection information addition step of adding the result detection information as the post-processed information.

3. The design review, progress check information transmission method according to claim 1, whereby the processing step includes:
a check item count acquisition step of obtaining a check item count, which indicates the number of check items designated during a time period for the design review process or the development process, for which monitor conditions are designated;
a result input count acquisition step of obtaining a result input count, which indicates the number of sets of results for the job start dates and the job end dates that have been entered; and
a progress achievement calculation step of calculating a progress achievement level based on the ratio of the result input count relative to the check item count.

4. The design review, progress check information transmission method according to claim 1, whereby the processing step includes:
a periodical monitoring step of monitoring the result input count and the progress achievement level, at a predetermined interval, for which monitoring conditions are designated in advance; and
a monitoring result addition step of adding the monitoring results as the post-processed information.

5. The design review, progress check information transmission method according to claim 1, whereby the processing step includes:
a history extraction step of extracting a history of the monitoring results for which monitoring conditions are designated; and
a history difference calculation step of calculating a historical difference in the monitoring results.

6. The design review, progress check information transmission method according to claim 1, whereby the processing step includes:
a behind-schedule detection step of determining whether the job start dates and the job end dates of the check items, for which the monitoring conditions are designated, are behind schedule;
a result input detection step of determining whether results for the job start dates and the job end dates for the check items have been entered; and
a request information addition step of when the job start dates and the job end dates are behind schedule, and when the results for the job start dates and the job end dates of the check items are not entered, adding request information as post-processed information.

7. The design review, progress check information transmission method according to claim 1, whereby the processing step includes a risk distribution coordinate creation step, for job importance levels and priority levels, that includes:
an orthogonal coordinates creation step of arranging cells in a matrix shape and creating orthogonal coordinates in consonance with the job importance levels and the priority levels of the check items;
a coordinate value calculation step of calculating coordinate values in accordance with sets of rank information, respectively consisting of the job importance levels and the priority levels of the check target items;
a unique code arrangement step of arranging and displaying the unique codes at the cells represented by the corresponding coordinate values; and
a hierarchical conversion step of performing a hierarchy display process for arranging the unique codes in the cells of the coordinate values.

8. The design review, progress check information transmission method according to claim 7, whereby, in addition to the risk distribution coordinate creation step, the processing step includes:
a display color setup step of setting a color correlation table indicating correlations, with display colors, of a non-setup state and a setup-complete state of the results for a job start date and a job end date for a check item, a behind-schedule state and a redo state; and
a progressing state color conversion step of changing colors, based on the color correlation table, of progressing states of the check items corresponding to the unique codes that are arranged in the individual cells at the risk distribution coordinates, and displaying the progressing states.

9. The design review, progress check information transmission method according to claim 7, whereby, in addition to the risk distribution coordinates creation step, the processing step includes:
a risk group sorting step of dividing the X axis and the Y axis for an orthogonal coordinating system in accordance with arbitrary rank values for the job importance levels and priority levels of the check items, and sorting the orthogonal coordinating system into risk groups located in four areas based on the importance levels and the priority levels;
a group check item count acquisition step of obtaining the number of check items that are entered in each of the four areas of the risk groups; and
a current status acquisition step of obtaining, for each of the areas of the risk groups, the number of items indicating a non-setup state and a setup-complete state of the results for the job start date and the job end date of the check item, a behind-schedule state and a redo state; and
a risk group status aggregation step of aggregating current status values for the individual areas of the risk groups.

10. A design review, progress check information transmission apparatus, for evaluating review items that are required for steps in a product development process, comprising:
a basic information setup unit, for establishing a design review process name, a development process name, and check items required for product development to determine business results;
a code provision setup unit, for selecting unique codes used for identifying the check items;
a rank setup unit, for designating, respectively, for a plurality of projects, rank information for job importance levels and priority levels for the check items;
a plan setup processor, for producing, respectively, for a plurality of jobs, schedules for job start dates and job end dates for the check items;
a result entering unit, for entering, respectively, for a plurality of projects, the results related to job start dates and end dates for the check items, and acceptance/rejection information pertaining to content checking;
a monitoring condition designation unit, for a member of a project execution department, for selecting and entering a plurality of desired monitoring conditions by referring to a name of a project for which a progress notification and risk information is requested, the check items, the unique codes, the schedules for the job start dates and end dates, the results obtained for the job start dates and the job end dates and the acceptance/rejection information;
a monitoring information extraction unit, for extracting information based on the monitoring conditions;
a processing unit, for processing the information extracted by the monitoring information extraction unit to obtain the essence of information;
a matching detection unit, for detecting a matching state wherein post-processed information obtained by the processing unit matches the monitoring conditions; and
an email transmission unit, for, following the detection of the matching state, creating text for an email to which is attached the essence of information and a detailed information reference URL, and for transmitting the email, via a communication line, to a designated transmission destination email address.

11. The design review, progress check information transmission apparatus according to claim 10, wherein the processing unit includes:
a result input detection unit, for detecting result detection information for determining whether the results for the job start dates and the job end dates for the check items, for which the monitoring conditions have been designated, have been entered; and
a result detection information addition unit, for adding the result detection information as the post-processed information.

12. The design review, progress check information transmission apparatus according to claim 10, wherein the processing unit includes:
a check item count acquisition function, for obtaining a check item count, which indicates the number of check items designated during a time period for the design review process or the development process, for which monitor conditions are designated;
a result input count acquisition function, for obtaining a result input count, which indicates the number of sets of results for the job start dates and the job end dates that have been entered; and
a progress achievement calculation function, for calculating a progress achievement level based on the ratio of the result input count relative to the check item count.

13. The design review, progress check information transmission apparatus according to claim 10, wherein the processing unit includes:
a periodical monitoring function, for monitoring the result input count and the progress achievement level, at a predetermined interval, for which monitoring conditions are designated in advance; and
a monitoring result addition function, for adding the monitoring results as the post-processed information.

14. The design review, progress check information transmission apparatus according to claim 10, wherein the processing unit includes:
a history extraction function, for extracting a history of the monitoring results for which monitoring conditions are designated; and
a history difference calculation function, for calculating a historical difference in the monitoring results.

15. The design review, progress check information transmission apparatus according to claim 10, wherein the processing unit includes:
a behind-schedule detection function, for determining whether the job start dates and the job end dates of the check items, for which the monitoring conditions are designated, are behind schedule;
a result input detection function, for determining whether results for the job start dates and the job end dates for the check items have been entered; and
a request information addition function, for, when the job start dates and the job end dates are behind schedule, and when the results for the job start dates and the job end dates of the check items are not entered, adding request information as post-processed information.

16. The design review, progress check information transmission apparatus according to claim 10, wherein the processing unit includes a risk distribution coordinate creation function, for job importance levels and priority levels, that includes:
an orthogonal coordinates creation function, for arranging cells in a matrix shape and creating orthogonal coordinates in consonance with the job importance levels and the priority levels of the check items;
a coordinate value calculation function, for calculating coordinate values in accordance with sets of rank information, respectively consisting of the job importance levels and the priority levels of the check target items;
a unique code arrangement function, for arranging and displaying the unique codes at the cells represented by the corresponding coordinate values; and
a hierarchical conversion function, for performing a hierarchy display process for arranging the unique codes in the cells of the coordinate values.

17. A design review, progress check information transmission apparatus according to claim 16, wherein, in addition to the risk distribution coordinate creation function, the processing unit includes:
a display color setup function, for setting a color correlation table indicating correlations, with display colors, of a non-setup state and a setup-complete state of the results for a job start date and a job end date for a check item, a behind-schedule state and a redo state; and
a progressing state color conversion function, for changing colors, based on the color correlation table, of progressing states of the check items corresponding to the unique codes that are arranged in the individual cells at the risk distribution coordinates, and displaying the progressing states.

18. The design review, progress check information transmission apparatus according to claim 16, wherein, in addition to the risk distribution coordinates creation function, the processing unit includes:
a risk group sorting function, for dividing the X axis and the Y axis for an orthogonal coordinating system in accordance with arbitrary rank values for the job importance levels and priority levels of the check items, and sorting the orthogonal coordinating system into risk groups located in four areas based on the importance levels and the priority levels;
a group check item count acquisition function, for obtaining the number of check items that are entered in each of the four areas of the risk groups; and
a current status acquisition function, for obtaining, for each of the areas of the risk groups, the number of items indicating a non-setup state and a setup-complete state of the results for the job start date and the job end date of the check item, a behind-schedule state and a redo state; and
a risk group status aggregation function, for aggregating current status values for the individual areas of the risk groups.
